(19) United States
(12) Patent Application Publication
(10) Pub. No.: US 2009/0304382 A1
(43) Pub. Date: Dec. 10, 2009

(54) CONTROL/MONITOR TERMINAL

(75) Inventors: Yoshitane SAITOU, Kameoka-shi (JP); Kenji NISHIKIDO, Osaka (JP)

Correspondence Address: GREENBLUM & BERNSTEIN, P.L.C., 1950 ROLAND CLARKE PLACE, RESTON, VA, 20191, US

(73) Assignee: ANYWIRE CORPORATION, Kyoto (JP)

(21) Appl. No.: 12/472,591

(22) Filed: May 27, 2009

(30) Foreign Application Priority Data
Jun. 6, 2008 (JP) 2008-173976

(51) Int. Cl. H04J 14/00

(52) U.S. Cl. 398/43

(57) ABSTRACT

Address setting and initial data setting of an oil-resistant, water-resistant control/monitor terminal for performing address setting and initial setting of control/monitor terminals of a transmission control system in an oil-mist or humid environment. Also provided is optical communications or electromagnetic induction through a light transmission window provided in the control/monitor terminal using a data-setting-circuit-equipped console.

### BACKGROUND OF THE INVENTION

1. Field of the Invention

The present invention relates to an oil-resistant, water-resistant electronic instrument setting apparatus used when setting the addresses of a master station and a plurality of slave stations connected to a transmission line and also used when performing the initial setting of a control unit in a transmission control system used in a work environment requiring oil resistance and/or water resistance.

2. Description of the Related Art

In a transmission control system in which a parent station and slave stations are distributed along a transmission line, the address setting for each station has been performed by an address switch or the like within the master station and the slave stations.

The environment for setting the address of each of the slave stations is required to be a highly clean one, and considering the setting work, the environment requires intervals between each setting section. In addition, any work undertaken after the setting work has been completed is complicated.

For example, Patent Document 1 describes an oil-resistant rubber switch and an electronic instrument using the same switch. Performing address setting using such an oil-resistant rubber switch, however, requires a large area for the installation location of the switch and as such, downsizing of the equipment cannot be achieved.

[Patent Document 1] Japanese Patent Application Laid-Open Publication No. 2003-086055 Oil-resistant rubber switch and electronic instrument using the same switch

The application system of Patent Document 1 requires a wide space for performing installation adjustments and setting work cannot be performed in a small area.

### [Patent Document 2] Japanese Patent Application Laid-Open Publication No. 2003-272754

The method described in Patent Document 2 requires a sealing structure in order to achieve an oil-resistant structure, thereby resulting in a cost increase in the end products.

### SUMMARY OF THE INVENTION

The present invention hermetically seals the electrical settings of an instrument and performs the setting thereof using an optical communication method, thereby eliminating the need for an oil-resistant sealing structure for the setting section and thereby protects the electronic circuits.

One feature of the present invention is to eliminate an oil-resistant sealing structure and perform the address setting and initial setting of a control unit in a reduced space, at a reduced size and at low cost.

A non-limiting feature of the present invention eliminates the oil-resistant seal structure and allows both address and initial setting of a control unit to be performed using light or electromagnetic induction.

According to one aspect of the present invention, there is provided a console and control/monitor terminal, which is a control/monitor signal transmission system including a plurality of controlled devices each of which includes a controlled section and a sensor section for monitoring the controlled section, wherein a control signal is transmitted as a transmission signal to the controlled section through a data signal line common to the plurality of controlled devices and a monitor signal from the sensor section is transmitted as a transmission signal, and which is a transmission control system connected to a transmission line provided with a master station which is connected to the data signal line and transmits a monitor signal transmitted from a predetermined controlled device as a control signal for a controlled device associated in advance and a plurality of slave stations which are provided in association with the plurality of controlled devices and are connected to the data signal line and corresponding controlled devices, wherein the address setting and initial value setting of the slave station are optically communicated to a data-setting-circuit-equipped console through a light transmission window of the slave station, wherein the slave station includes a light emitting element and a light receiving element for performing address setting and initial value setting, and wherein the data-setting-circuit-equipped console is provided with a light emitting element and a light receiving element. This structure eliminates the need for a switch structure for address setting and can reduce failure factors such as deterioration failure and faulty contacts in a switch section. Performing address setting and initial data writing using the light emission signal through the light transmission window allows the control/monitor terminal to be hermetically-sealed from the outside and to maintain airtightness, thereby providing an oil-resistant, water-resistant structure.

According to another aspect of the present invention, there is provided the console and control/monitor terminal as detailed above, which is the control/monitor signal transmission system which transmits a control signal to the controlled section through the common data signal line and transmits a monitor signal from the sensor section to the data signal line, wherein the same address is set for a light receiving section unit and a light emitting section unit, each of which is a slave station, the control signal is sent as a light emission signal from the light emitting section unit in the same clock cycle of the same address of the transmission signal, is received as a monitor signal by the light receiving section unit during the light emission period of the light emission signal, and is sent as the transmission signal to the common data signal line. The light reception signal received by the light receiver as the monitor signal is sent as an input signal, or a current signal, to the transmission line. Since the input signal, or the monitor signal, indicates the presence of an object to be detected, the master station can recognize the presence of the object to be detected by the monitor signal of that address. Since the addresses of the light emitter side and the light receiver side are the same, the light emission timing and the light reception timing operate in sync with each other. An other light emission signal is not received by mistake, thereby allowing highly reliable detection of the object to be detected to be performed.

This structure can immediately reflect input information in the output signal, allowing the response speed of each sensor to be increased. The input signal as the current signal is obtained in the first-half low voltage level part. With the first-half pulse width as the input signal, an output signal as the current signal may be carried in the latter-half low voltage level.

According to another aspect of the present invention, there is provided the console and control/monitor terminal as detailed above, wherein the light emitting section unit and the light receiving section unit in pairs are set to be the same address of the transmission signal in order to constitute a transmission sensor, wherein a plurality of the transmission sensors constitute an area sensor for detecting an object to be detected within a specific area. A plurality of light emitters and light receivers in pairs are used to constitute a sensor area, wherein either a part of or all the monitor signals detect the presence or absence of the object to be detected, thereby achieving the area sensor.

According to another aspect of the present invention, there is provided the console and control/monitor terminal system as detailed above, wherein only a managing slave station provided at the top of cascade-connected slave stations is provided with the light emitting element and the light receiving element which optically communicates with the data-setting-circuit-equipped console through the light transmission window, and when the address or initial setting value of the managing slave station is set by the data-setting-circuit-equipped console, an address generated by the managing slave station is set for the dependent slave station which is cascade-connected to the managing slave station, and successively added address values are taken over by a cascade line, allowing the address or initial value of the dependent slave station to be successively set. In this case, a plurality of cascade-connected control/monitor terminal systems do not require address setting and this has the advantage of simplifying the address setting work and initial data setting work at the time of system startup and system change.

According to another aspect of the present invention, there is provided the console and control/monitor terminal system as detailed above, wherein a freely deformable wiring or support structure is provided between the data-setting-circuit-equipped console and a tip section provided with the light emitting element and the light receiving element. The control/monitor terminal system using a wire-saving technique for reducing wiring can reduce not only the amount of wiring but also the size of the installation location and thereby downsize the system itself. A work area when setting work is performed manually is not required, and the setting operation can be performed by simply bringing the light emitting section and the light receiving section into close contact with the light transmission window. The light emitting section, the light receiving section, and the data-setting-circuit-equipped console can perform address setting and initial data setting easily, even if there is only sufficient space through which the freely deformable wiring or support structure can pass, thereby achieving both downsizing and space-saving easily.

According to another aspect of the present invention, there is provided the console and control/monitor terminal system as detailed above, wherein a control/monitor terminal provided with a communication section which optically communicates with the data-setting-circuit-equipped console protects a circuit of the control/monitor terminal which has a hermetically-sealed structure. The console and control/monitor terminal system is suitable for use in an oil-dispersing environment, a humid environment, or a reactive-gas environment.

According to another aspect of the present invention, there is provided the console and control/monitor terminal system as detailed above, wherein the tip section provided with the light emitting section and the light receiving section connected to the data-setting-circuit-equipped console through a freely deformable wiring or arm structure is half-fixed to the light transmission window provided with the communication section of the control/monitor terminal for performing optical communications using magnetic material fixing, fitting, engagement, or hook in order to provide a structure wherein a light transmitting/receiving section can be fixed during optical setting. This fixing method allows for stable setting work without impairing communication accuracy due to vibrations or fluctuations during address or initial data setting work. Installation and adjustment can be performed in the above-described narrow location, thereby achieving downsizing, weight reduction, and cost reduction across the entire system.

According to another aspect of the present invention, there is provided the console and control/monitor terminal system as detailed above, wherein the data-setting-circuit-equipped console constituting the console is operated by a battery or a secondary battery, and when it is operated by the secondary battery the console includes a charging circuit.

According to another aspect of the present invention, there is provided the console and control/monitor terminal system as detailed above, wherein the power source of the data-setting-circuit-equipped console is connected to a signal transmission line or a power line in order to receive a power supply. This can potentially downsize or even eliminate a battery or secondary battery within the console, thereby achieving downsizing and weight reduction of the console.

According to another aspect of the present invention, there is provided the console and control/monitor terminal system as detailed above, wherein as a substitute for light, electromagnetic communications are performed through a nonmagnetic hermetically-sealed casing structure. In a state of waiting for adjustment after installation, a master station operation of the control/monitor terminal system is set to be in a non-operating state, and the slave station receives the write command and following address signal sent from the console to the transmission line. By using an operation in which the slave station stores the address as its own address through the removal of a reflective tape on the slave station, the address of the slave station from which the reflective tape has been removed is then set. The console, on completion of the address setting of the slave station, increments the address number and sends it to the transmission line. The reflective tape of the slave station is then removed in order to set the address of the next slave station. Until the address number reaches the one input in the console in advance, the above-described operation is repeated in order to complete the address setting.

According to another aspect of the present invention, there is provided the console and control/monitor terminal system as detailed above, wherein the data-setting-circuit-equipped console constituting the console is connected to the signal transmission line, all sensor windows of the control/monitor terminals for which the address is set are optically sealed to achieve internal reflection, an address non-setting state is recognized, and at the time of address setting an address is set in order of removing the seal.

The control unit and setting device of the present invention can easily provide an oil-resistant structure.

### BRIEF DESCRIPTION OF THE DRAWINGS

FIG. 1 is a block diagram of a communication control system according to an embodiment of a control/monitor terminal system of the present invention;

FIG. 2 is a block diagram of a reflection sensor terminal used as a control/monitor terminal in the control/monitor terminal system;

FIG. 3 is a block diagram of an MCU of the reflection sensor terminal;

FIG. 4 is a time chart of the control/monitor terminal system;

FIG. 5 is a block diagram of a transmission sensor terminal used as a control/monitor terminal in the control/monitor terminal system;

FIG. 6 is a block diagram of an MCU of a light receiving section of the transmission sensor terminal;

FIG. 7 is a block diagram of an MCU of a light emitting section of the transmission sensor terminal;

FIG. 8 is a block diagram of a console used in the control/monitor terminal system;

FIG. 9 is a block diagram of an MCU of the console;

FIG. 10 is a view illustrating an appearance of the console;

FIG. 11 is a view illustrating a connecting section of the console and a light emitter/receiver;

FIG. 12 is a time chart of a transmission signal in the control/monitor terminal system;

FIG. 13 is a time chart during address writing of address setting performed in the console;

FIG. 14 is a time chart during address reading of address setting performed by the console;

FIG. 15 is a time chart of a data signal in the control/monitor terminal system;

FIG. 16 illustrates an example in which the transmission sensor terminal is provided;

FIG. 17 illustrates a light emission side of an area sensor terminal configured by the transmission sensor terminal;

FIG. 18 is a view illustrating a connecting section of the console and a transmission signal line;

FIG. 19 is a view illustrating a different connection state of a connecting section of the console and a transmission signal line; and

FIG. 20 is a view illustrating a connection state of the console and a connecting section of FIG. 19.

### DESCRIPTION OF THE PREFERRED EMBODIMENTS

Hereinafter, the control unit and setting device of the present invention will be described on the basis of the embodiments included herein with reference to the drawings.

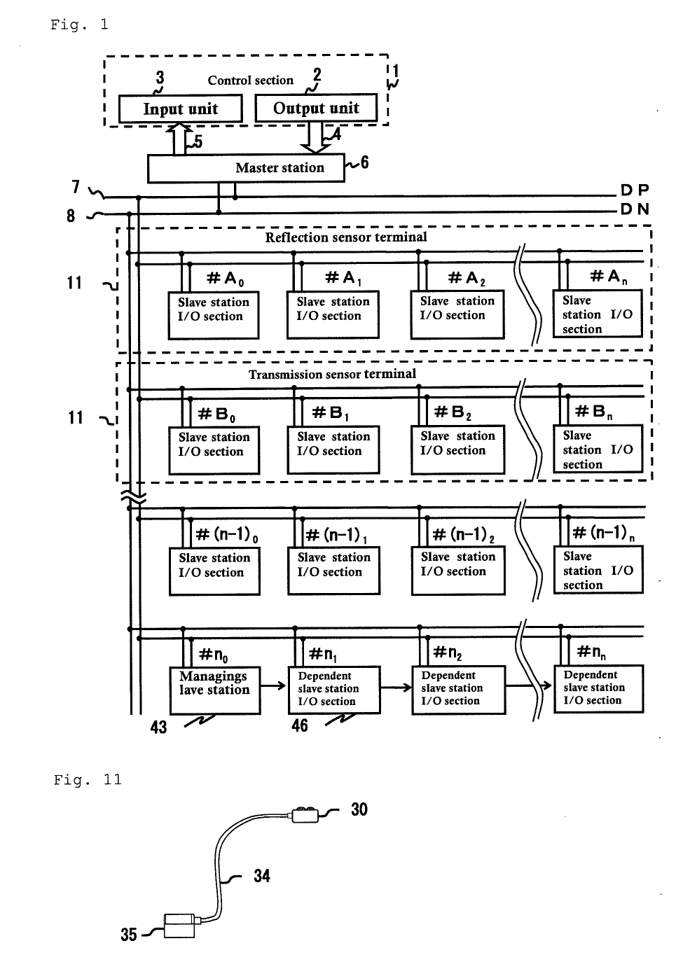

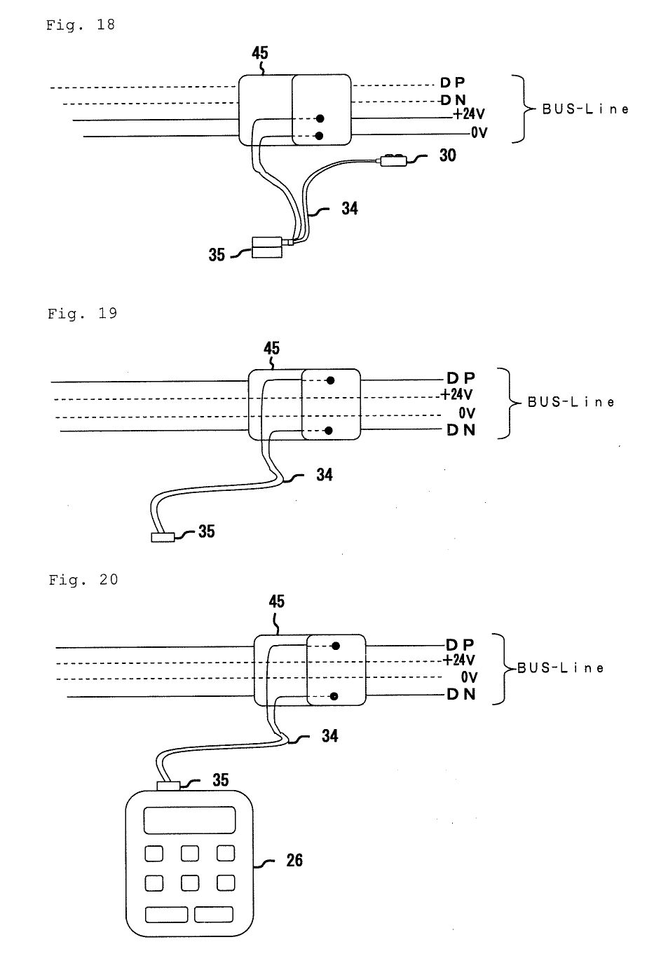

The oil-resistant control unit and setting device of the present invention will be described with reference to FIGS. 1 to 20.

FIG. 1 shows an example of a communication control system block diagram according to one embodiment of the present invention.

In FIG. 1, a control section 1 gives and receives a parallel signal to and from a master station 6, receives a monitor signal 5 from a plurality of various kinds of slave stations connected to a transmission line DP signal line 7 and a DN signal line 8 by an input unit 3, and delivers a control signal 4 to the plurality of various kinds of slave stations from an output unit 2. As an example of the slave station, a sensor system 11 is described, which is a reflection sensor terminal and a transmission sensor terminal, in which a large number of slave station input/output sections are connected. For these large number of slave station input/output sections, at installation, positioning within the entire system is required to be performed by address setting, and the initial setting of data is required to be performed within the slave station at power on or it is set externally. In the present invention, these address settings and initial data settings are performed using a control unit with a hermetically-sealed structure which does not cause deterioration and failure in system instruments in an oil-polluted environment or in a humid environment through a light transmission window 33

In order to perform address setting and initial data setting, a specific address of a control/monitor terminal is set through a rotary switch and a DIP switch by opening a plastic cover in an address switch part attached to the control/monitor terminal. In this regard, switches and electronic circuits are protected from adhesion of surrounding dust and contamination simply by means of the plastic cover. In the automation of machine assembly factories and food factories, however, in an oil mist or humid environment, oil and water drops enter switches and electronic circuits, causing failure through faulty contacts and insufficient circuit insulation.

The present invention provides the switches and electronic circuits of a control/monitor terminal with a perfect hermetically-sealed structure in order to make the structure resistant to an oil mist or humid environment and this allows the address setting and initial data setting of the control/monitor terminal to be performed using optical communications through the light transmission window 33. In this case, given the structure of the data-setting-circuit-equipped console and the light transmission window 33, a sealing method and a communication setting section used herein must simultaneously satisfy the requirement of being low-priced, have good operability, be small, and have excellent reliability.

At the lowermost column of FIG. 1 a managing slave station 43 and a dependent slave station 46 cascade-connected to the managing slave station are shown. In the relationship between the managing slave station 43 and the dependent slave station 46, when address setting and initial data setting are performed through the light transmission window of the managing slave station 43 only, address setting and initial data setting for the dependent slave station 46, which is cascade-connected to the managing slave station 43, can be successively performed, thereby allowing address setting and initial data setting for a plurality of control/monitor terminals to be performed automatically. This allows address setting and initial data setting performed during system installation to be performed extremely easily, and in addition, the dependent slave station 46, which does not have a light transmission window, exhibits excellent downsizing capabilities and sealing properties, is low-priced, and provides ease of operation.

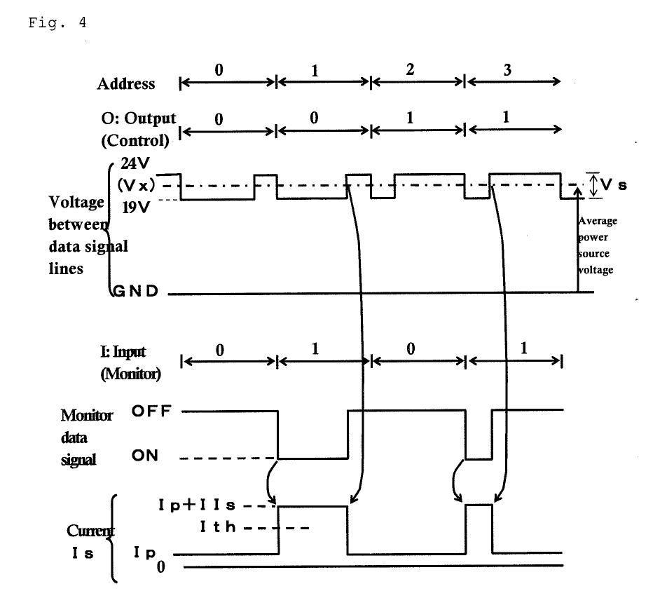

In FIG. 1, only the managing slave station 43 is provided with a light emitting element and a light receiving element which optically communicate with a data-setting-circuit-equipped console 26 (shown in FIG. 5) through a light transmission window.

When the address or initial set value of the managing slave station 43 is set by the data-setting-circuit-equipped console 26, an address generated by the managing slave station is set for the dependent slave station 46, which is cascade-connected to the managing slave station, and successively added address values are taken over by a cascade line, allowing the address or initial set value of the dependent slave station 46 to be successively set.

FIG. 2 shows a reflection sensor terminal block according to another embodiment of the present invention.

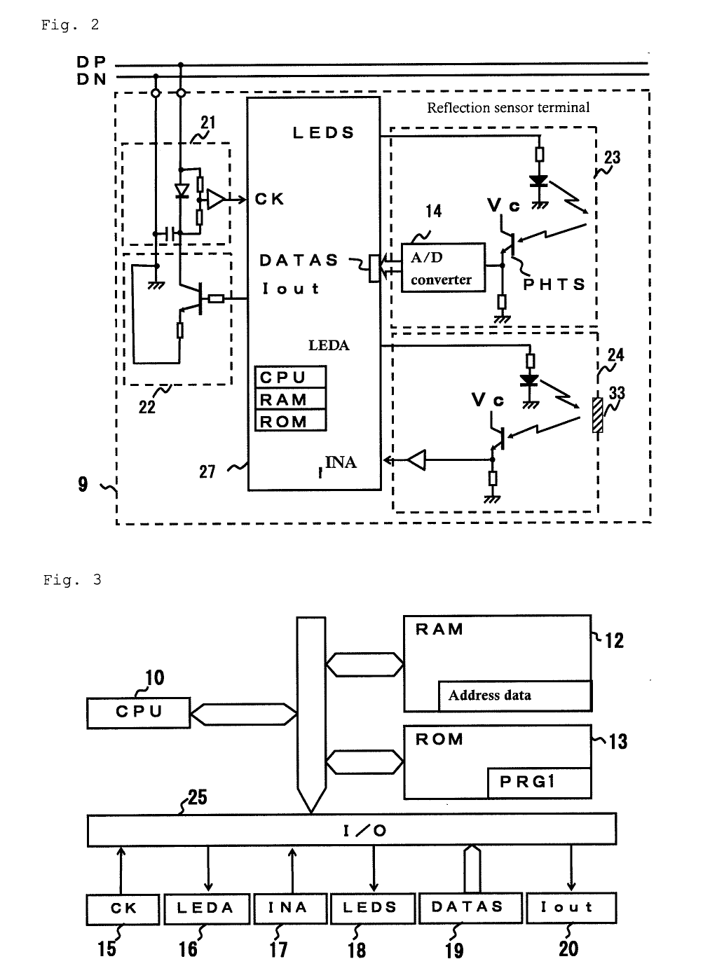

In FIG. 2, a sensor section 9 includes an MCU 27, which performs a central function, a CK signal extraction circuit 21, an output circuit 22, a communication setting section 24, a light emitting/receiving section 23, and an A/D converter 14 for converting a received signal from an analog signal into a digital signal, all of which constitute the reflection sensor terminal. The sensor section 9 is connected to a transmission line DP signal line 7 and a DN signal line 8, which transmit a CK signal 15 (shown in FIG. 3) to the MCU 27, which performs a central function in the sensor section 9, through the CK signal extraction circuit 21. The communication setting section 24 drives a light emitting diode and allows it to emit light, thereby providing a light emitter for performing optical communications with the below-described data-setting-circuit-equipped console 26 through the light transmission window 33 using an LEDA signal 16, which is output from the MCU 27. A light reception signal received from the data-setting-circuit-equipped console 26 through the light transmission window 33 is converted into an electrical signal by a phototransistor, and a signal, being an INA signal 17 (shown in FIG. 3), is analyzed within the MCU 27 in order to establish communication.

After performing the initial setting, the light receiving phototransistor is then in the standby state in order to receive a light emitting signal from the data-setting-circuit-equipped console 26. The signal from the console 26 is sent as a console side LEDC signal, as shown in the address writing flow chart in FIG. 13. For example, the communication setting section 24 of a transmission sensor terminal (light reception) 11 shown in FIG. 5 and the transmission sensor terminal (light emission) 11 also shown in FIG. 5, for which an address is set, receives a console side LEDC signal, receives an INA signal 17 which begins with a StartBit and includes a write command and address data n on the terminal side, captures it in an MCU 27, obtains the write command as a write instruction, and stores the address data n as the address of own station in an address storage area of a storage area RAM 12 (shown in FIG. 3).

Then, an LEDA signal 16 (shown in FIG. 3) is sent from the sensor terminal to the data-setting-circuit-equipped console 26. The LEDA signal 16, as shown in FIG. 13, attaches a StartBit and address data n recognized as the address of own station, and sends it. The data-setting-circuit-equipped console 26 which has received the LEDA signal 16, as shown in FIG. 13, receives the StartBit and address data n which has been written in the sensor terminal, displays it on the console, and at the same time displays the completion of the accurate writing with an LED display.

In FIG. 2, the sensor section 9 is a reflection sensor terminal, and its detection section, or light emitting/receiving section 23, emits light for detecting an object to be detected from a light emitting diode using an LEDS signal 18 (shown in FIG. 3), or an output from the MCU 27. A light emitting signal emitted from the light emitting diode is reflected by the object to be detected, and the reflected light is received by a phototransistor PHTS. The received signal is converted from an analog signal to a digital signal by an A/D converter 14, and is captured as a DATAS signal 19 (shown in FIG. 3) by the MCU 27 in order to determine the presence or absence of the object to be detected. The MCU 27 sends the result of the presence or absence of the object to be detected as an electrical signal, or an Iout signal 20 (shown in FIG. 3), to the master station 6 or an intermediate station from a transmission line DP signal line 7 and a DN signal line 8.

Although FIG. 2 does not show the initial setting of the MCU 27, the A/D converter 14, the data capture fetch timing and the analog-to-digital conversion timing of the A/D converter 14, a chip which includes the A/D converter 14 in the MCU 27 is commercially available, and in reality a chip having the A/D converter 14 located therewithin is used, allowing the initial setting to be performed using a program PRG1 written within a ROM 13.

FIG. 3 shows an MCU block diagram according to another embodiment of the present invention.

FIG. 3 is a block diagram illustrating the part of the MCU 27 shown in FIG. 2. A CPU 10 for performing calculations, signal processing, determination, and control, a writable storage element RAM 12, and the ROM 13 for storing programs and fixed data are connected through an internal bus. The CPU 10 is connected to an I/O bus 25 through the internal bus and connected to an input/output interface device. The CPU 10 captures a CK signal 15, the INA signal 17, and the DATAS signal 19 as input signals and outputs the LEDA signal 16, the LEDS signal 18, and the Iout signal 20. The CPU 10 performs initialization by the initialization program PRG1 stored in the ROM 13 concurrently with power-on, activates the communication setting section 24, waits for an address setting signal from the data-setting-circuit-equipped console 26, and stands by. The address setting for the sensor section 9 is completed by the below-described communication procedure shown in FIGS. 12 and 13. On completion of the address setting, light emission for the sensor is then started in order to begin monitoring of the presence or absence of an object to be detected.

FIG. 4 shows a system time chart according to another embodiment of the present invention.

On the uppermost part of the figure, I/O address time intervals are shown. Each time interval assigned to each address from “0” to “3” is t0 period. When a current Is, or an input signal, is detected on the front side t0/4 of the time interval, as shown in the I/O address “2” and I/O address “3,” by receiving the detection signal, the residual 3t0/4 output signal is made “High” to reflect the input signal in the output within the same address signal. When this technique is used, the current Is, or the input signal, is received in the first half t0/4 while the latter half 3t0/4 is made “High,” thereby allowing both input and output to be performed within one pulse cycle. Reflecting the input in the output within one pulse cycle simultaneously is defined as full-duplex communication. When full-duplex communication is used, by setting the same address for the light emission side of the transmission sensor terminal 11 and the light reception side of the transmission sensor terminal 11 shown in FIG. 5, a pair of light emitting/light receiving sensors can be configured.

FIG. 5 shows a transmission sensor terminal block diagram according to another embodiment of the present invention.

In the figure, the sensor system 11 outlined by the broken border on the left of the figure is the light receiving section of the transmission sensor terminal, while the sensor system 11 outlined by the broken border on the right of the figure is the light emitting unit of the transmission sensor terminal. The same address is programmed to be set for the light emitting unit and the light receiving unit connected to the transmission line DP signal line 7 and the DN signal line 8, and, in addition, the address setting is set to be the same address, thereby configuring a pair of transmission sensor terminals.

In the figure, the data-setting-circuit-equipped console 26 is a unit for performing the address setting and initial data setting of the control/monitor terminal. The light emitting section and the light receiving section of the reflection sensor terminal are separated, and each of them is controlled by each MCU 27, thereby constituting the transmission sensor terminal. By performing optical communications with the data-setting-circuit-equipped console 26 through the light transmission window 33 of the control/monitor terminal as the slave station, both address setting and initial value setting are performed. The control/monitor terminal as the slave station provided with the light emitting element and the light receiving element for performing the optical communications and the data-setting-circuit-equipped console 26 provided similarly with the light emitting element and the light receiving element allow address setting and initial value setting to be undertaken in an oil-resistant structure.

The optical communications are performed through the light transmission window 33. As a substitute for light, electromagnetic communications may be performed through a nonmagnetic hermetically-sealed casing structure (not shown).

FIG. 5 is an example of a control/monitor signal transmission system which transmits a control signal to a controlled section and transmits a monitor signal from a sensor section to a data signal line through a common data signal line. The same address is set for the light receiving unit and the light emitting unit, each of which is the slave station, and within the same clock cycle of the same address of the transmission signal the control signal is sent as a light emitting signal from the light emitting unit, which is received as a monitor signal by the light receiving unit in the light emitting period of the light emitting signal, and which is sent as the transmission signal to the common data signal line, thereby achieving the transmission control/monitor terminal system.

FIG. 6 shows an MCU block diagram according to another embodiment of the present invention.

FIG. 6 is a block diagram of the MCU 27 of the light receiving section of the transmission sensor terminal shown in FIG. 5. The CPU 10 for performing calculations, signal processing, determination, and control, the writable storage element RAM 12, and the ROM 13 for storing programs and fixed data are connected through the internal bus. The CPU 10 is connected to the I/O bus 25 and is connected to the input/output interface device through the internal bus. The CPU 10 captures the CK signal 15, the INA signal 17, and the DATAS signal 19 as input signals and outputs the LEDA signal 16, and the Iout signal 20. The CPU 10 performs initialization using an initialization program PRG2 stored in the ROM 13 concurrently with power-on, activates the communication setting section 24, waits for an address setting signal from the data-setting-circuit-equipped console 26, and stands by. The address setting for the sensor section 9 is completed by the below-described communication procedure shown in FIGS. 12 and 13. On completion of the address setting, light reception for the sensor is then started in order to begin monitoring for the presence or absence of an object to be detected.

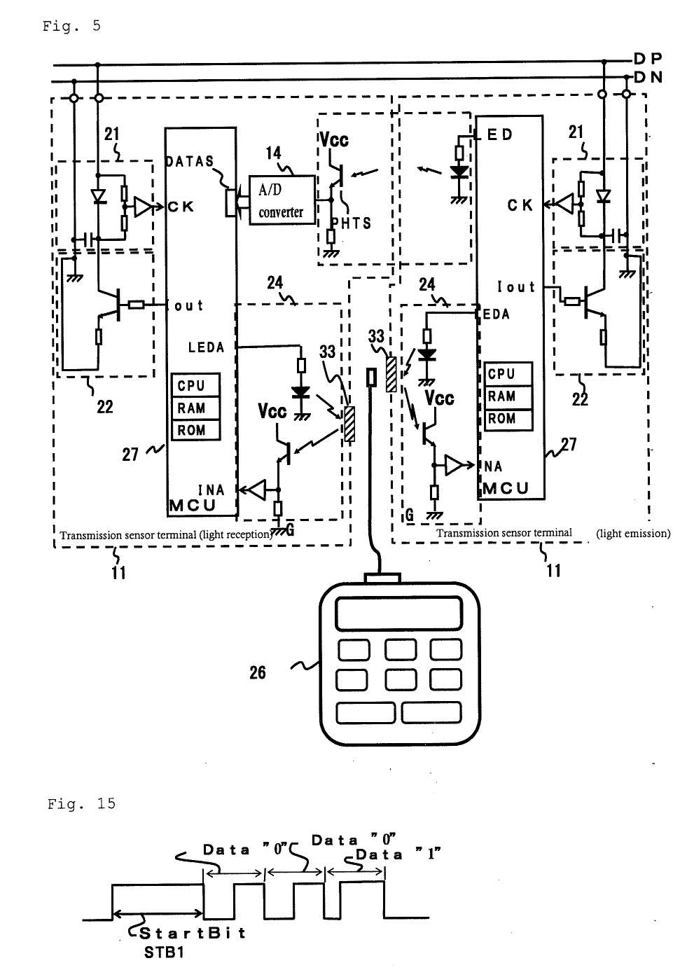

FIG. 7 shows a block diagram of an MCU according to another embodiment of the present invention.

FIG. 7 is a block diagram of the MCU 27 of the light emitting unit of the transmission sensor terminal shown in FIG. 5. The CPU 10 for performing calculations, signal processing, determination, and control, the writable storage element RAM 12, and the ROM 13 for storing programs and fixed data are connected through the internal bus. This configuration is the same as that of FIG. 7. The CPU 10 is connected to the I/O bus 25 and is connected to the I/O interface device through the internal bus. The CPU 10 captures the CK signal 15 and the INA signal 17 as input signals and outputs the LEDA signal 16, the LEDS signal 18, and the Iout signal 20. The CPU 10 performs initialization using an initialization program PRG3 stored in the ROM 13 concurrently with power-on, activates the communication setting section 24, waits for an address setting signal from the data-setting-circuit-equipped console 26, and stands by.

The address setting for the sensor section 9 is completed by the communication procedure shown in FIGS. 12 and 13. On completion of the address setting, the light emission for the sensor is then started in order to begin light emission for monitoring the presence or absence of the object to be detected.

An LEDC signal 31 emitted from the console includes a StartBit indicating the start of the signal, a write command for instructing address writing, and address data n. The sensor terminal receives a series of these LEDC signals 31 from the console as the INA signal 17 and returns the LEDA signal 16, as a verification signal, to the console. The console captures the LEDA signal 16 as the INA signal 17, thereby allowing the setting completion display and the set address display on the console to be performed.

FIG. 8 shows the data-setting-circuit-equipped console 26, the light emitting/receiving section 30, a signal line section 34, and the light transmission window 33 of the control/monitor terminal device according to another embodiment of the present invention. The data-setting-circuit-equipped console 26 includes the MCU 27 including the CPU 10, the RAM 12, the ROM 13, and the input/output interface circuit, a KEY input section 28 for inputting an address and initial setting data, a display section 29 for displaying input data and address data after setting, the status of the data-setting-circuit-equipped console 26, and the status of the control/monitor terminal device, a power source section, the signal line section 34, and the light emitting/receiving section 30. A situation is schematically shown in which communications are performed with the communication setting section 24 of the sensor section 9, or with the control/monitor terminal device, through the light transmission window 33 of the control/monitor device.

When a communication control system is installed or a control/monitor terminal device is replaced, in order to perform the address setting and the initial data setting of the control/monitor terminal device, a person who performs the setting work inputs address data and initial setting data required for the data-setting-circuit-equipped console 26 from the KEY input section 28. The display section 29 displays the data and displays data input instructions, the input mode state, and the monitor state of the control/monitor terminal device. The KEY input section 28 includes a data input key and a function key for mode switching and constitutes the console together with the display section 29. In FIG. 8, the power source of the console incorporates a battery, by which the console is operated. A rechargeable battery may be used which provides are chargeable power source from the transmission signal line DP signal line 7 and the DN signal line 8. In a method having a power-source line other than the transmission signal line, the +24V and 0V lines may be used as a rechargeable power source. As one example of a connection method, as will be described below with reference to FIG. 18, connection with a BUS-Line through a T-branch connector will be shown.

The data-setting-circuit-equipped console 26 constituting the console is operated by a battery and a secondary battery. The secondary battery includes a rechargeable circuit.

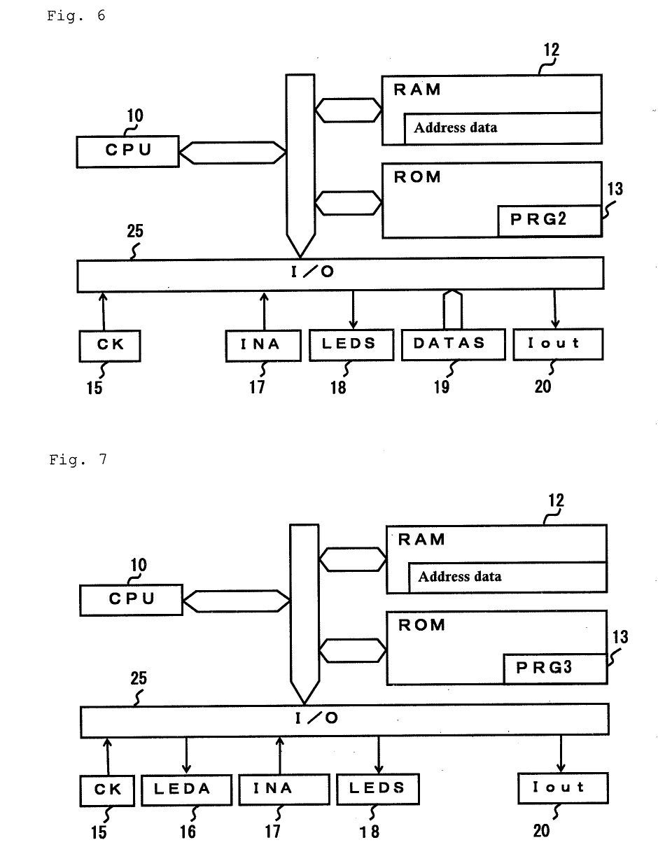

FIG. 9 shows an MCU block diagram according to another embodiment of the present invention.

FIG. 9 is a block diagram of the part of the MCU 27 shown in FIG. 8. The CPU 10 for performing calculations, signal processing, determination, and control, the writable storage element RAM 12, and the ROM 13 for storing programs and fixed data are connected through the internal bus. The CPU 10 is connected to the I/O bus 25 and is connected to the I/O interface device through the internal bus. The CPU 10 captures, as input signals, an INC signal 32 and a KEY input signal from the KEY input section 28 and outputs an LEDC signal 31 and a DISPLAY signal to the display section 29.

The CPU 10 performs initialization using an initialization program PRG4 stored in the ROM 13 concurrently with power-on, while on completion of the KEY input of address setting data, a transfer key is pressed in order to allow the LEDC signal 31 to be transmitted through the signal line section 34 from the light emitter of the light emitting/receiving section 30 to the control/monitor terminal. When the LEDC signal 31 reaches the communication setting section 24 from the light transmission window 33 of the control/monitor terminal device, the address setting and initial data setting of the control/monitor terminal device are written. The communication procedure for the writing/reading is performed as shown in below-described FIGS. 12 and 13. On completion of the address setting, the display of the address setting state of the control/monitor terminal device and the operation state of the control/monitor terminal device are captured once in the data-setting-circuit-equipped console 26, and are displayed by the display section 29.

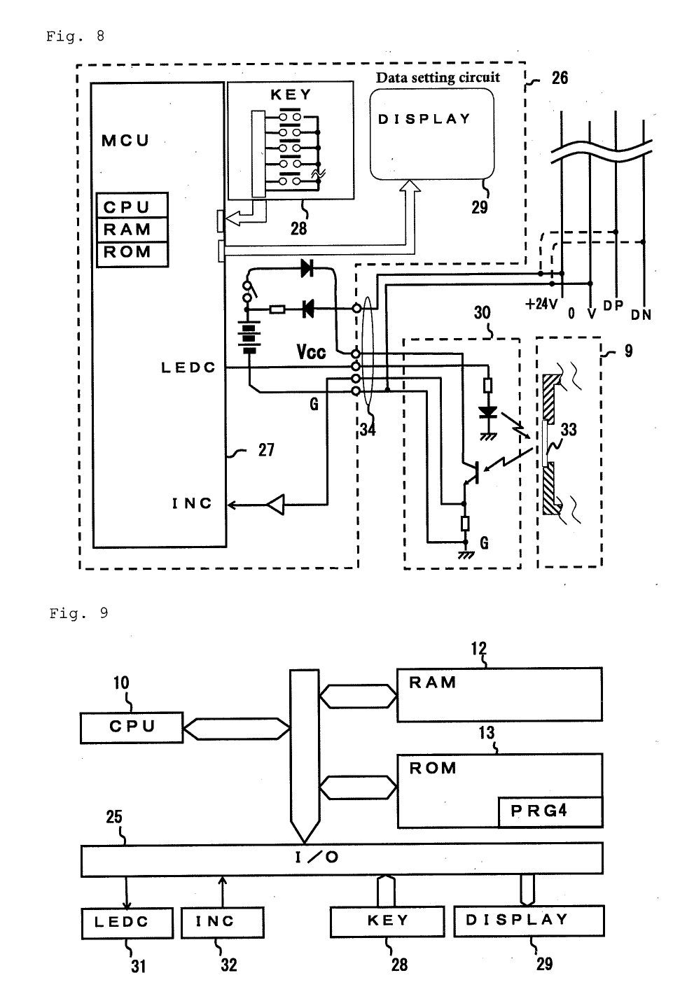

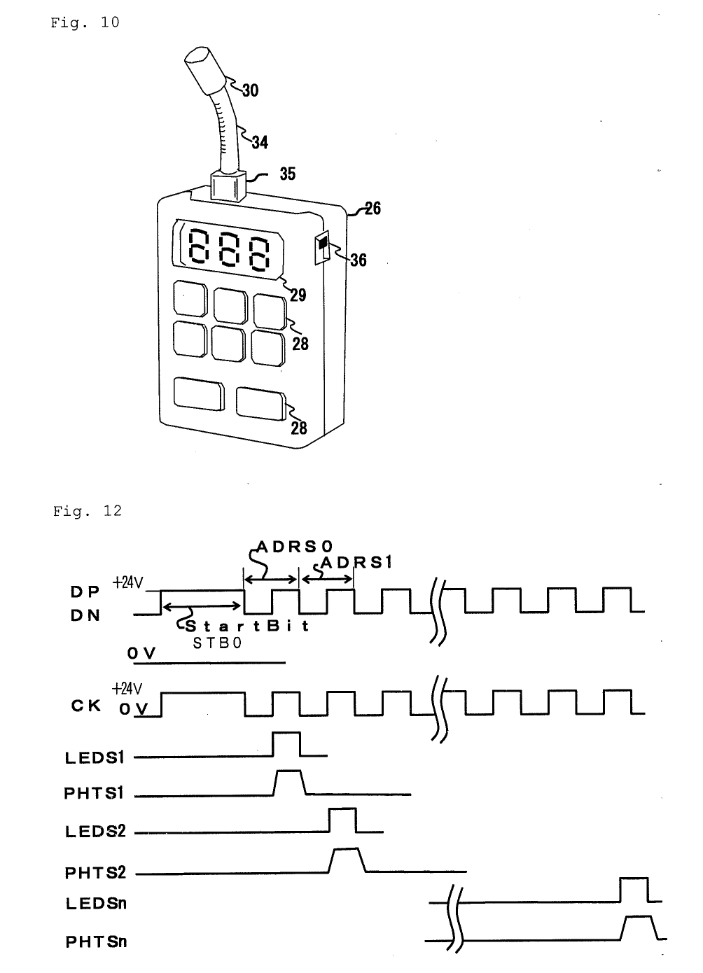

FIG. 10 shows an outline view of a data-setting-circuit-equipped console according to another embodiment of the present invention.

In the figure, the data-setting-circuit-equipped console 26 includes the KEY input section 28, the display section 29, and a power switch 36, and is connected to the light emitting/receiving section 30 via a connector 35 through the signal line section 34.

In order to perform the address setting and the initial data setting of the control/monitor terminal device, a person who performs the setting work, when a communication control system is installed or a control/monitor terminal device is replaced, inputs predetermined address settings and initial data settings through the operation of a KEY of the KEY input section 28 while viewing the display contents of the display section 29 and presses the transfer key of the KEY input section 28 in order to allow a data signal to be emitted from the light emitter.

When the power switch 36 is turned on, together with the initialization of the MCU, the initial setting program and the address setting program PRG4 within the ROM 13 are performed. On the display section, the option as to whether address setting is performed, the transfer of the initial data is performed, or the set address is checked is selected by the function setting key, starting the communications from the console to the sensor terminal. In the figure, the signal line section 34 is designed to be freely deformed, bringing the light emitting/receiving section 30 into contact with the light transmission window of the control/monitor terminal device, of which the address is set, thereby allowing address setting operations to be easily performed even in a narrow space.

FIG. 11 shows a view of a light emitter/receiver connecting section according to another embodiment of the present invention.

In the figure, the connection from the connector 35 to the light emitting/receiving section 30 through the signal line section 34 is not limited to the flexible type like the signal line section 34 shown in FIG. 10 and may be a simple cable, allowing setting operations to be easily performed in a narrower space.

In this case, a permanent magnet may be installed around the light emitting/receiving section 30 in order to allow it to be electromagnetically fixed to the light transmission window 33 of the control/monitor terminal device. Stability during communications may be achieved by a fitted structure or a hook (not shown).

A tip section provided with a light emitting element and a light receiving element connected to the data-setting-circuit-equipped console 26 through flexible wiring or an arm structure is half-fixed to a light transmission window provided in a communication section for performing the optical communications for a control/monitor terminal by a fixture method using the attraction force of magnets and magnetic material fixing, a mechanical fit/engage structure, or a hook in order to allow the light transmitting/receiving section to be fixed during optical communication setting, thereby providing the control/monitor terminal system and the light emitting/receiving section 30 with a structure suitable for performing optical communications stably.

FIG. 12 shows a time chart according to another embodiment of the present invention.

In the figure, the transmission line DP signal line 7 and the DN signal line 8 carry +24V, or the peak pulse voltage of the DN signal line 8, with respect to 0V, while the DN signal line 8 carries a signal which is lower than +24V by the equivalent of the wave height of a signal pulse. The signal starts with a StartBit, followed by ADRS0 data and ADRS1 data with the number of control/monitor terminal devices connected to the transmission line, and returns to a StartBit again. The StartBit has a length five times longer than the data signal and is identified as a start signal.

The control/monitor terminal device rectifies part of the signal of the transmission line DP signal line 7 and the DN signal line 8 and obtains a power source by charging a capacitor.

The method for obtaining a power source provides a wire-saving structure.

The MCU 27 receives the CK signal 15 obtained by the CK signal extraction circuit 21 as a basic input signal in order to allow the master station and each slave station to operate as a communication control system. A light emission signal of the first sensor section 9 positioned at ADRS0 emits light at a first pulse leading edge after the StartBit in order to obtain a light reception signal PHTS1, which is the reception of a detection signal of the object to be detected as reflected light by the phototransistor. Similarly, it emits light at a second pulse leading edge in order to obtain a reception signal PHTS2, which is the reception of a detection signal of the object to be detected as reflected light by the phototransistor. Light emission signals LEDSn and light reception signals PHTSn of n sensor sections 9 are thus obtained. When a signal of the last nth sensor section 9 is obtained, the signal returns to a StartBit again in order to repeat the cycle.

FIG. 13 shows a time chart during address writing according to another embodiment of the present invention. The address writing is performed, as shown in the figure, by the LEDC signal 31 transmitted from the console. The address writing signal transmits STB1 as a StartBit, a write command as a writing instruction immediately after it, and address data n. The sensor terminal which has received the address writing signal receives as the INA signal STB1 as a StartBit, a write command as a writing instruction immediately after it, and address data n and recognizes the address value of the sensor terminal as the address data n. The sensor terminal then emits light STB1 as a StartBit and the address data n as its own address value immediately after it as LEDA. The console recognizes STB1 as a StartBit and the address data n as the address value of the sensor terminal immediately after it in order to check the address writing.

FIG. 14 shows a time chart during address reading according to another embodiment of the present invention.

In the figure, address reading is performed by the LEDC signal 31 transmitted from the console. The console, when performing address reading, transmits a read command immediately after STB1 as a StartBit. The sensor terminal receives the read command immediately after STB1 as a StartBit, then transmits the address data n of the sensor terminal immediately after STB1 StartBit as the LEDA signal. The console receives the LEDA signal as the INC signal in order to read the address data n.

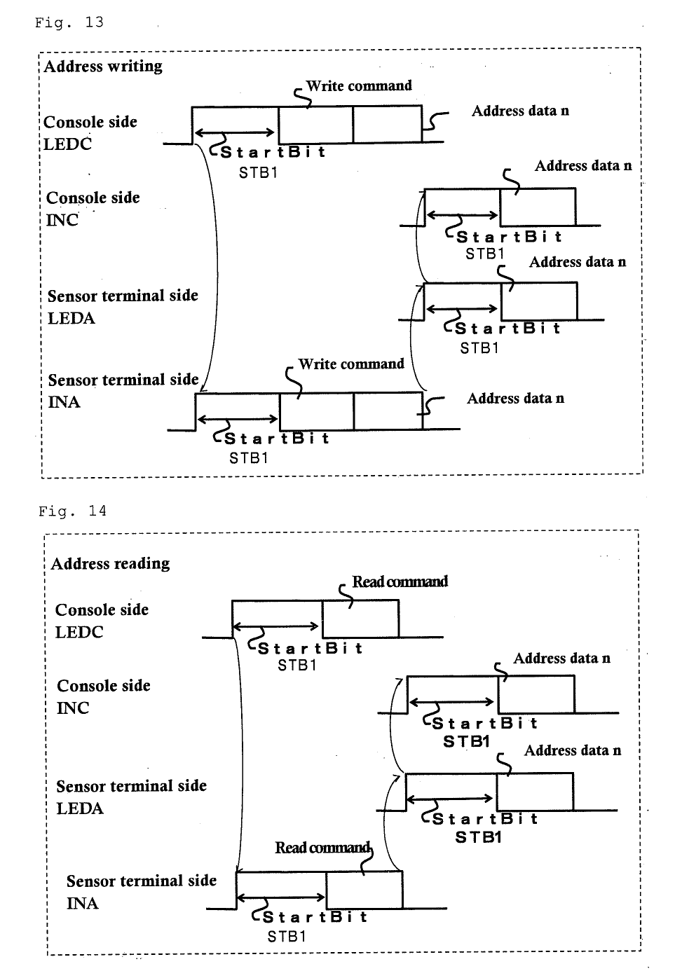

FIG. 15 shows a data signal time chart according to another embodiment of the present invention.

FIG. 15 shows an example of a transmission signal on the transmission line. In the figure, the pulse signal immediately after STB1 as a StartBit has the same pulse width in LOW and HIGH, and data in this case indicates data “0”. The following second pulse also indicates data “0”. The third pulse, however, has a shorter period in LOW, indicating data “1”. The transmission control system is operated by these signal forms.

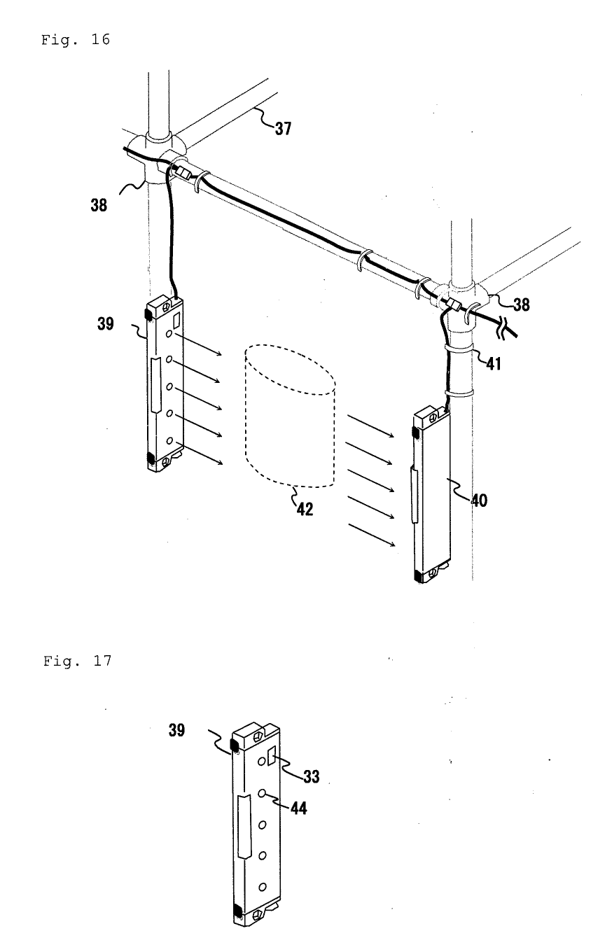

FIG. 16 shows a view showing an installation example of a transmission sensor terminal.

In the example of the transmission sensor terminal, as shown in the figure, a light emitting unit 39 and a light receiving unit 40 are placed across an object to be detected 42. In this example, they are fixed to a pipe rack 37. The pipe rack 37 constitutes a three-dimensional rack using a connecting part 38. A plurality of sensor terminals is installed on the transmission line using a T-branch connector or the like. The transmission line fixes the wire with wiring fixing members 41 which are appropriately spaced apart. In the transmission sensor terminal, in contrast to the reflection sensor which shows the presence of the object to be detected when reflected light is present, the reception signal is LOW in the presence of the object to be detected and is HIGH in the absence of the object to be detected.

In this case, the light emitting section unit 39 and the light receiving section unit 40, which are a plurality of control/monitor terminal systems connected to the common data signal line DP signal line 7 and the DN signal line 8, have a structure incorporating a plurality of pairs of transmission terminal systems. The same address is set for the light emitting section unit 39 and the light receiving section unit 40 by the console 26 of the present invention, and the address value is set for the address of the light emitting circuit and the light receiving circuit following a managing slave station within the light emitting section unit 39 or light receiving section unit 40 by a cascade connection. The addresses of the plurality of light emitting circuits or light receiving circuits of the light emitting section unit 39 and the light receiving section unit 40 can thus be set in pairs. The detection result of the object to be detected which has been detected by a plurality of light emitting circuits and light receiving circuits in pairs is sent to the master station connected to the common data signal line DP signal line 7 and the DN signal line 8. The master station converts the detection result signal received as a serial signal into a parallel signal and transmits whether the object to be detected has been detected by the detection circuits forming a pair or the detection circuits forming a plurality of pairs through the input unit of the control section.

When such an area sensor is constituted, for each address of a plurality of light emission sides and a plurality of light reception sides, setting only the address of the managing slave station to which the top address is assigned allows the address of the dependent slave station to be successively set on an incremental basis by a cascade connection, thereby allowing address setting to be performed in a short time.

In the conventional detection system for an object to be detected using a plurality of light emitters and light receivers, a problem often occurs in which a light emission signal for the next sensor or another separate sensor is detected by a light receiver. By using a signal processing system which obtains an input signal as a current signal in the pulse-first-half low-voltage level part of a pulse cycle constituting an address and reflects the input signal result in the pulse-latter-half pulse width and outputs it, the light receiver does not receive the light transmission signal for the next sensor or another separate sensor by mistake and therefore, a highly reliable area sensor can be provided. In addition, use of the above-described address setting method of the managing slave station allows an address setting operation to be easily performed at the time of control/monitor terminal device installation or unit replacement.

FIG. 17 shows the light emission side of an area sensor terminal according to another embodiment of the present invention.

The light emitting section unit 39 in the figure includes the light transmission window 33 for writing an address and a light emitting section 44. The light receiving section 40 also has a light receiving window (not shown) for receiving the light emitted from the light emitting section 44, and they are positioned facing each other. The light emitting section unit 39 and the light receiving section unit 40 are placed with their optical axes optically aligned. In this case, the same address is set for the light emitting section unit 39 and the light receiving section unit 40, and this can be processed as the presence/absence sensor signal of the object to be detected within one pulse, as in the case of the reflection signal.

The mechanism in which the same address is set for the light emitting section unit 39 and the light receiving section unit 40, and the mechanism in which the light receiving section is operated with the light emission timing of the light emitting section will be described according to the time chart shown in FIG. 4. On the uppermost part of the figure, input/output address time intervals are shown. The time intervals assigned to each address from “0” to “3” are shown here as an example. Each I/O address time interval is t0 period, of which the front side t0/4 is the period of the input signal. The period of the input signal is, as shown in the voltage signal diagram of the data signal line, in the 19V level, which is lower than the 24V level by 5V. In the 5V-low voltage level period, a current Is indicating the presence of the input signal can be sent. When the current Is is detected, as shown in the I/O address “2” and I/O address “3,” by receiving the detection signal, the residual 3t0/4 output signal is made “High” in order to reflect the input signal in the output within the same address signal.

When using this technique, the current Is, or the input signal, is received in the first half t0/4 while the latter half 3t0/4 is made “High,” thereby allowing input and output to be performed within one pulse cycle. Reflecting the input in the output within one pulse cycle simultaneously is defined as full-duplex communication, which is a technique that allows the input signal and the output signal to be carried within the period of the same pulse. When full-duplex communication is used, by setting the same address for the light emission side of the transmission sensor terminal 11 and the light reception side of the transmission sensor terminal 11 shown in FIG. 5, a pair of light emitting/light receiving sensors can be configured.

FIG. 18 shows a view of a data-setting-circuit-equipped console connecting section according to another embodiment of the present invention.

In the figure, an example is shown in which the connector 35 connecting the light emitting/receiving section 30 and the signal line section 34 is connected to the power line of the bus line through the T-branch connector 45 in order to obtain the power source of the data-setting-circuit-equipped console 26. Accordingly, the console 26 does not need a power source such as a battery power source, and as such, it achieves battery management, downsizing and weight reduction with respect to the shape used.

When the power source of the data-setting-circuit-equipped console 26 is connected to a signal transmission line or a power line in order to receive a power supply, a secondary battery is eliminated, achieving further both weight reduction and downsizing of the console 26.

FIG. 20 shows a view of a data-setting-circuit-equipped console connecting section according to another embodiment of the present invention. Using a reflective tape, the light transmission window 33 of the control/monitor terminal device is sealed by the reflective tape in order to receive the reflection of the light emission signal at all times, and address setting is performed by recognizing the removal of the reflective tape, simplifying address setting work.

In the example shown in the figure, the data-setting-circuit-equipped console 26 is connected to the branch connector 45 through the signal line section 34 on the connector 35 of the console. Following that, the number of the control/monitor terminal device of which the address is set is input into the console in advance. Each time the address of the control/monitor terminal device is set, the counter number of the input value of the number of control/monitor terminal device is decreased. When the counter number reaches “0”, the completion of address setting is recognized, and a program is run to terminate the address writing operation.

For the control/monitor terminal device in which, by using the reflective tap, the light transmission window 33 of the control/monitor terminal device is sealed by the reflective tape in order to receive the reflection of the light emission signal at all times, the address is set to be a specific address value at its initial setting.

For example, for the control/monitor terminal device of which the address is not set, the address, when the address value is a 4-bit address, is set to be 1111. It is therefore recognized that the address is not set for the control/monitor terminal device of which the address is 1111.

Following that, the state of the light transmission window 33 is read, and if own light transmission signal is received by the reflective tape at all times, it is determined that the state is not in the address writing state. Next, when the seal of the reflective tape is removed at the time of address setting, the address setting signal sent from the console through the transmission signal line is detected to write the address value following the address setting signal which is written in the address storage area as own address. The control/monitor terminal device of which own address has been written in the address storage area sends a write completion signal to the console. The console which has received the write completion signal sends the next address value setting signal to the transmission signal line and waits for the timing at which the seal of the reflective tape of the light transmission window 33 of the control/monitor terminal device of which the address is not set is removed. Through this series of operations, the address setting of the control/monitor terminal is performed until the counter value of the console reaches “0” (not shown).

The present invention provides, easily and at low cost, an oil-resistant structure for the address setting section of an electronic control device installed in an environment which requires oil resistance such as a machine assembly factory and an electronic control device including such can be widely applied in an oil-resistant or oil-mist environment.

According to the present invention, a low-cost, space-saving, and downsized device can be achieved and the address setting and initial setting of a control/monitor terminal can be performed reliably in an oil-polluted, humid environment.

The present disclosure relates to subject matters contained in Japanese Patent Application No. 2008-173976 (filed on Jun. 6, 2008), which is expressly incorporated herein, by reference, in its entirety.

What is claimed is:

1. A control/monitor terminal, comprising:
in a control/monitor signal transmission system which, in a plurality of controlled apparatuses each of which includes a controlled section and a sensor section monitoring a controlled section, transmits a control signal as a transmission signal to the controlled section through a common data signal line and transmits a monitor signal from the sensor section as a transmission signal,
the control/monitor terminal which is provided corresponding to the plurality of controlled apparatuses, is connected to the data signal line and a corresponding controlled apparatus, is connected to a master station, through the data signal line, which transmits a monitor signal transmitted from a predetermined controlled apparatus as a control signal for a predetermined corresponding controlled apparatus, and includes a light emitting section and a light receiving section which perform address setting or initial value setting,
wherein address setting or initial value setting are performed by optical communication with a data-setting-circuit-equipped console through a light transmission window.

2. The control/monitor terminal of claim 1, further comprising:
a light receiving section unit including the light receiving section and a light emitting section unit including the light emitting section,
wherein the same address is set for the light receiving section unit and the light emitting section unit, and within the same clock cycle of the same address of the transmission signal, a light emission signal is sent from the light emitting section unit based on a control signal, is received as a monitor signal by the light receiving section unit during a light emission period of the light emission signal and is sent as a transmission signal to the common data signal line.

3. The control/monitor terminal of claim 2, wherein a pair of the light emitting section unit and the light receiving section unit configure a transmission sensor, and a plurality of transmission sensors configure an area sensor which detects an object to be detected within a certain area.

4. The control/monitor terminal of claim 2, wherein the light emitting section unit and the light receiving section unit are sealed.

5. The control/monitor terminal of claim 1, wherein the light transmission window is half-fixed to a tip section provided with the light emitting section and the light receiving section connected to the data-setting-circuit-equipped console through a freely deformable wiring or arm structure using magnetic material fixing, fitting, engagement, or hook.

6. The control/monitor terminal of claim 4, wherein the light transmission window is half-fixed to a tip section provided with the light emitting section and the light receiving section connected to the data-setting-circuit-equipped console through a freely deformable wiring or arm structure using magnetic material fixing, fitting, engagement, or hook.

7. A control/monitor terminal, comprising:
in a control/monitor signal transmission system which, in a plurality of controlled apparatuses each of which includes a controlled section and a sensor section monitoring a controlled section, transmits a control signal as a transmission signal to the controlled section through a common data signal line and transmits a monitor signal from the sensor section as a transmission signal,
the control/monitor terminal which is provided corresponding to the plurality of controlled apparatuses, is connected to the data signal line and a corresponding controlled apparatus, is connected to a master station, through the data signal line, which transmits a monitor signal transmitted from a predetermined controlled apparatus as a control signal for a predetermined corresponding controlled apparatus, is surrounded by a sealed structure case which is made of a non-magnetic substance, and performs address setting or initial value setting by electromagnetic induction communication with a data-setting-circuit-equipped console through the sealed structure case.

8. A control/monitor terminal system, comprising:
a plurality of controlled apparatuses each of which includes a controlled section and a sensor section monitoring a controlled section;
a master station which is connected to a common data signal line and transmits a monitor signal transmitted from a predetermined controlled apparatus as a control signal for a different corresponding controlled apparatus; and
a plurality of control/monitor terminals which are provided corresponding to the plurality of controlled apparatuses and are connected to the data signal line and the corresponding controlled apparatus,
wherein a control signal is transmitted as a transmission signal through a common data signal line, and a monitor signal from the sensor section is transmitted as a transmission signal, and
in the control/monitor terminal, only a managing slave station provided at the top among a plurality of slave stations which are cascade-connected includes a light emitting section and a light receiving section for performing address setting or initial value setting, address setting or initial value setting is performed by optical communication with a console provided with a data setting circuit through a light transmission window of the managing slave station, a dependent slave station which is cascade-connected with the managing slave station is set to an address generated by the managing slave station when an address or an initial setting value of the managing slave station is set, an address value which is sequentially added is relayed by a cascade line, and an address or an initial setting value of the dependent slave station is sequentially set.

9. The control/monitor terminal system of claim 8, wherein the data setting circuit is connected to the data signal line, the optical transmission window of the control/monitor terminal of an object to be set is optically sealed, a state in which an address is not set yet is recognized, and an address is set in an order of removing the seal when setting an address.

10. A control/monitor terminal system, comprising:
a plurality of controlled apparatuses each of which includes a controlled section and a sensor section monitoring a controlled section;
a master station which is connected to a common data signal line and transmits a monitor signal transmitted from a predetermined controlled apparatus as a control signal for a different corresponding controlled apparatus; and
a plurality of control/monitor terminals which are provided corresponding to the plurality of controlled apparatuses and are connected to the data signal line and the corresponding controlled apparatus,
wherein a control signal is transmitted as a transmission signal through a common data signal line, and a monitor signal from the sensor section is transmitted as a transmission signal, and
in the control/monitor terminal, only a managing slave station provided at the top among a plurality of slave stations which are cascade-connected is surrounded by a sealed structure case which is a non-magnetic substance, address setting or initial value is performed by electromagnetic induction communication with a data-setting-circuit-equipped console through the sealed structure case, a dependent slave station which is cascade-connected with the managing slave station is set to an address generated by the managing slave station when an address or an initial setting value of the managing slave station is set, an address value which is sequentially added is relayed by a cascade line, and an address or an initial setting value of the dependent slave station is sequentially set.

11. A console for a control/monitor terminal, comprising:
a wiring or support structure which is freely deformable between with a tip section provided with the light emitting section and the light receiving section.

12. The console of claim 11, wherein in a control/monitor signal transmission system which, in a plurality of controlled apparatuses each of which includes a controlled section and a sensor section monitoring a controlled section, transmits a control signal as a transmission signal to the controlled section through a common data signal line and transmits a monitor signal from the sensor section as a transmission signal, an electric power source is connected to the data signal line to be supplied with electric power.

13. The control/monitor terminal of claim 3, wherein the light emitting section unit and the light receiving section unit are sealed.

14. The control/monitor terminal of claim 2, wherein the light transmission window is half-fixed to a tip section provided with the light emitting section and the light receiving section connected to the data-setting-circuit-equipped console through a freely deformable wiring or arm structure using magnetic material fixing, fitting, engagement, or hook.

15. The control/monitor terminal of claim 3, wherein the light transmission window is half-fixed to a tip section provided with the light emitting section and the light receiving section connected to the data-setting-circuit-equipped console through a freely deformable wiring or arm structure using magnetic material fixing, fitting, engagement, or hook.
